(19) United States
(12) Patent Application Publication
(10) Pub. No.: US 2006/0020491 A1
(43) Pub. Date: Jan. 26, 2006

(54) Batch processing method for patient management

(75) Inventors: Luc R. Mongeon, Minneapolis, MN (US); Marta E. Jackson, Lino Lakes, MN (US); Daniel T. Boulay, Bloomington, MN (US)

Correspondence Address: MEDTRONIC, INC., 710 MEDTRONIC PARK, MINNEAPOLIS, MN, 55432-9924, US

(73) Assignee: Medtronic, Inc.

(21) Appl. No.: 10/946,473

(22) Filed: Sep. 21, 2004

Related U.S. Application Data
(60) Provisional application No. 60/589,252, filed on Jul. 20, 2004.

(51) Int. Cl. G06Q 50/00

(52) U.S. Cl. 705/2; 705/9

(57) ABSTRACT

A method for managing data from remotely located patients features batch processing. Patient files are batched in groups to increase workflow efficiency of a caregiver clinic. Scheduling of remote data transmission; accessing, reviewing and evaluating the data; and billing are carried out using a batch processing approach.

### CROSS-REFERENCE TO RELATED APPLICATION(S)

This application claims the benefit of U.S. Provisional Application No. 60/589,252 filed on Jul. 20, 2004, for “Batch Processing Method for Patient Management” by L. Mongeon, M. Jackson, and D. Boulay.

### INCORPORATION BY REFERENCE

The aforementioned U.S. Provisional Application No. 60/589,252 is hereby incorporated by reference in its entirety.

### BACKGROUND OF THE INVENTION

The present invention is a method for managing data from remotely located patients. In particular, the present invention is a method for managing data from remotely located patients being monitored by a medical device.

In the past, patients monitored by medical devices, especially implantable medical devices (IMDs), were required to make regular in-office visits at a caregiver clinic. The medical devices were interrogated at each visit in order to obtain the data for the caregiver to review.

With the advent of technologies such as the Medtronic CareLink® Network by Medtronic, Inc., caregivers are able to review medical device interrogations transmitted by remotely located patients. However, clinics have tried to manage data from remote patients similarly to patients evaluated during in-office visits. Current workflow processes usually manage one patient file at a time. Each step taken for managing the patient, from scheduling to billing, is usually done individually for each file in a sequential manner. In this type of scenario, logging on to a network system, accessing, and then reviewing the data is performed separately for every patient file, which does not maximize efficiency of the caregiver's time and resources, or take full advantage of the benefits possible with the new technology. Therefore, there is a need for a method of gaining workflow efficiencies in clinics that utilize technologies for remotely located patients.

### BRIEF SUMMARY OF THE INVENTION

The present invention is a method of managing data from remotely located patients. Patient files are placed in groups, and data is received from the patients in the group during a specified time period. The data is reviewed and patient reports are created that prioritize the patients based on the amount of evaluation and response required by a caregiver. The caregiver subsequently evaluates the patient reports. Each step is carried out utilizing a batch processing approach.

### BRIEF DESCRIPTION OF THE DRAWINGS

FIG. 1 is a schematic view of a remote monitoring system.

FIG. 2 is a flowchart of one embodiment of a batch processing method.

FIG. 3 is an example of a graphical user interface that may be used with the present invention.

FIG. 4 is an example of a graphical representation of data accompanying a full report.

### DESCRIPTION

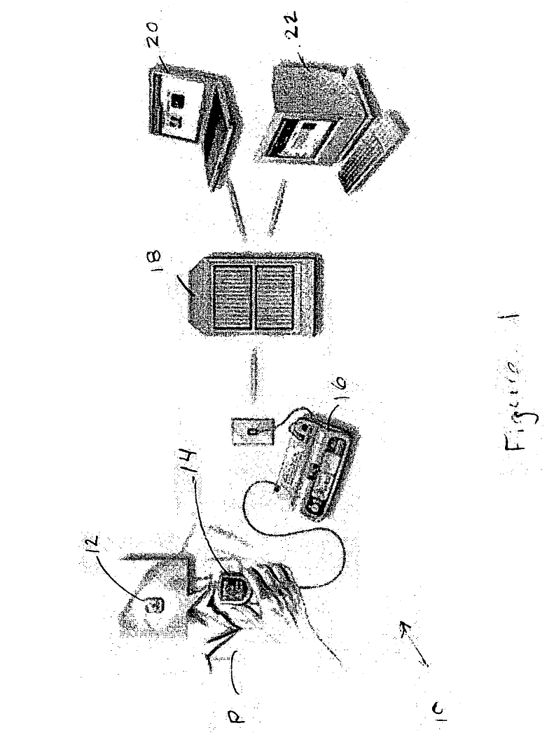

FIG. 1 illustrates a system by which patients interrogate an IMD and transmit the gathered data to a caregiver clinic. System 10 includes patient P with IMD 12, antenna 14, monitor 16, network server 18, and remote terminals 20 and 22. Antenna 14 is coupled to monitor 16, which is in communication with network server 18. Communication, as shown here, is through a standard phone line although other forms of communication of data may also be used. Network server 18, in turn, is in communication with remote terminals 20 and 22 through a network such as the Internet.

In operation, patient P may be scheduled to transmit data, patient P may self-elect to transmit data, or the caregiver may have requested patient P to transmit the data, because patient P experienced a clinical event. Antenna 14 is placed near enough to IMD 12 that data stored in IMD 12 can be transmitted to antenna 14 and stored by monitor 16. Patient P initiates uploading of the data via monitor 16, which transmits the data to network server 18. Alternatively, uploading may be initiated automatically via a signal generated from an outside source. Remote terminals 20 and 22 are utilized by the caregiver to access the data for review. The present invention is based on managing data from patients that utilize this type of system.

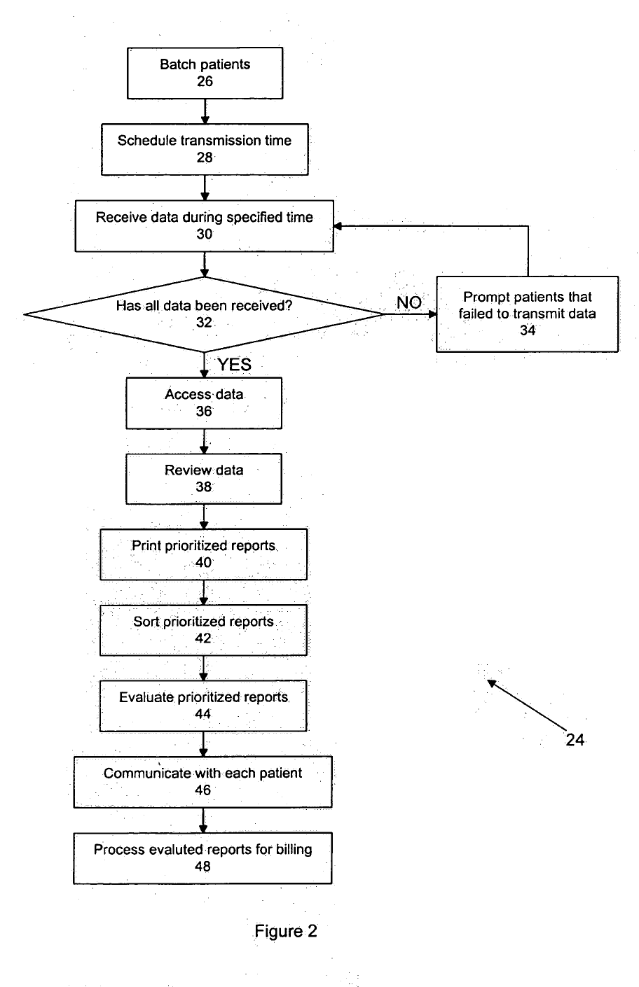

FIG. 2 illustrates one embodiment of method 24 of the present invention. To begin, at step 26, patient files are placed into a group. The caregiver determines the number of patient files to be batched together into a group. The number of patient files per group varies depending on the time allotted for review and evaluation of the data and reports, but, in one embodiment, at least five patient files are batched in order to gain efficiency. The more time allotted for the process, the larger the number of patient files batched into the group.

In one embodiment, patients are randomly grouped. There is no need to segment the patients in order to take advantage of the efficiencies that the method provides. The efficiencies will become apparent in the discussion below.

At step 28, the caregiver schedules the group of patients to transmit data from their medical device during a specified time period. The specified time should be within about 48 hours prior to review and evaluation of the data. For example, the specified time may be within about 24 hours prior to review and evaluation.

Next, the network server for storing data (e.g. network server 18 of FIG. 1) receives the data that is transmitted by each patient at step 30. Each patient should transmit during the specified time period scheduled for his or her batch or group. The length of the time period may vary and is chosen by the caregiver, however, it should be long enough to be accommodating for the patients.

Patient initiation of data transmission may occur in any number of ways. One embodiment is described in reference to FIG. 1, which shows patient P utilizing antenna 14 and monitor 16 to transmit data. Here, monitor 16 is a stationary device that is typically kept at a patient's home. A patient may not have time to transmit prior to leaving for work and must carry out transmission after returning home. Conversely, another patient may work in the afternoon and evening and must transmit data in the morning. As shown by these examples, the window of time for transmission should accommodate these types of schedules.

At step 32, the caregiver determines, at the end of the specified time period, whether data was received from all patients in the group. The Medtronic Paceart® System, for example, allows for automated detection of missed transmissions that were prescheduled. If not all patients have transmitted their data, at step 34, those patients may be prompted to transmit data during a given time period. Prompting may be done by phone, fax, or email or in any equivalent medium that allows for immediate communication with patients.

Once prompted, data is again received during a specified time period as shown at step 30. Step 32 is repeated, where the data is again reviewed to determine if a complete set of data has been received. Alternatively, patients failing to transmit data during the specified time period may be prompted after review of the data. These patients may be reassigned to another batch or group or be considered a new batch or group.

When all data is received or the specified time period expires, the data is accessed as a batch at step 36. Again, any missed transmissions may be rescheduled such that those patients are incorporated into a different batch. At this point, the caregiver accessing the data does not need to be medically trained personnel. The caregiver simply logs onto the system and accesses the data of the patients in the group from the network server. The caregiver prints initial reports as a batch based on the data. For example, patients with no clinical or device issues will have a brief report printed, while patients with clinical and/or device issues will have a full report printed. The batch of initial reports is then handed off to a medically trained caregiver to review the data as a batch. The system may provide users with specified reports saved by caregivers that help facilitate the generation of reports by selecting a specified user or profile and automatically generating the reports needed for batch processing.

Alternatively, step 36 may be carried out by a medically trained caregiver who also reviews the data. When step 36 is performed in this manner, the data may be electronically accessed as a batch, which eliminates the need to print the data. Here, the caregiver scans the batch of data for all patients.

At step 38, the accessed data is reviewed, or triaged, as a batch by a medically trained caregiver. A set of criteria may be developed to help facilitate the triage process. A period of time is blocked off to review the batch of data. The length of time will depend on the number of patient files in the group. Here, review is limited to identifying patients with clinical and/or device issues first. As stated above, steps 36 and 38 may be consolidated and carried out by a medically trained caregiver. The choice is a preference of the caregiver clinic.

At step 40, a batch of prioritized reports is printed for patients in the group. Patients that have no issues are given lower priority, and a brief report is printed for these patients. Brief reports contain little detail but essentially provide information showing that there are no clinical or device issues. Patients having clinical and/or device issues are given higher priority, and full reports are printed for these patients.

Next, at step 42, the prioritized reports are sorted based on their priority. Low priority reports are grouped together, and high priority reports are grouped together. Typically, only a small percentage of patients will have clinical and/or device issues. Sorting the prioritized reports enables the caregiver to know immediately whether any significant time is required for each patient's data and if the patient needs to be seen or contacted.

At step 44, a medically trained caregiver evaluates the prioritized reports as a batch. Again, the evaluation time is blocked off on the caregiver's schedule, and the length of time depends on the number of patient files in the batch. The caregiver indicates the proper treatment and follow-up for each patient, which is entered into the patient record by appropriate personnel. Follow-up may include office visits, physician consults, or other tests or procedures.

In an alternate embodiment, steps may be consolidated and carried out electronically by the caregiver evaluating the data. The caregiver accesses the data as a batch as in step 36. However, the caregiver then evaluates the batch of data without prioritizing and printing a report. This embodiment may require a larger time commitment from that caregiver. The choice of embodiments is a preference of the caregiver clinic.

The results of the evaluations are communicated to the patients at step 46. Any of a number of options may be utilized to communicate with the patients such as auto-generated follow-up letters listing the next appointment (either via remote or in-office) using the Medtronic Paceart® System, for those patients without any device issues or symptoms. In addition, the appropriate follow-up indicated by the caregiver is also communicated at step 46.

The evaluated reports are processed for billing at step 48. Processing of reports for billing is also carried out in batches. Thus, batch processing is utilized throughout the process to increase the efficiency of clinic workflow and make better use of resources.

As a specific example, a clinic provides services to patients with IMDs supported by e.g., the Medtronic CareLink® Network. The caregivers have designated one hour every week to evaluating device data that is received from remotely located patients. Thus, routine follow-up is performed remotely instead of requiring the patients to come to the clinic for in-office visits.

Based on an evaluation time of one hour, 20 patient files are randomly clustered into a group or batch. These groups will be managed together by the clinic.

A group of patients is scheduled to transmit device data on a specific Monday between 8:00 am and 8:00 pm, which is a large enough window of time to provide flexibility to the patients. Transmissions are scheduled on Mondays, Tuesdays, Wednesdays, or Thursdays so that evaluation may be performed the following day.

Next, patients transmit their device data during the scheduled period. The clinic may prompt patients prior to the scheduled transmission time to remind them to transmit device data during the scheduled time period. Patients are encouraged not to transmit data for scheduled follow-ups prior to their scheduled transmission time. Data transmitted prior to a scheduled transmission time (and not reviewed earlier or out of sequence) period will not include the most recent data when reviewed at the scheduled time. Additionally, the amount of stored data may surpass the capacity of the memory of the IMD if the length of time between transmissions is prolonged for too long.

After 8:00 pm on Monday, the caregiver determines whether data from every patient in the group was received. Patients that did not transmit data are contacted to prompt them to do so as soon as possible. As described above, patients may be prompted by phone, email, etc. The caregiver may continue to check for complete data transmission and prompt patients, if necessary, up until the data is accessed for the review process.

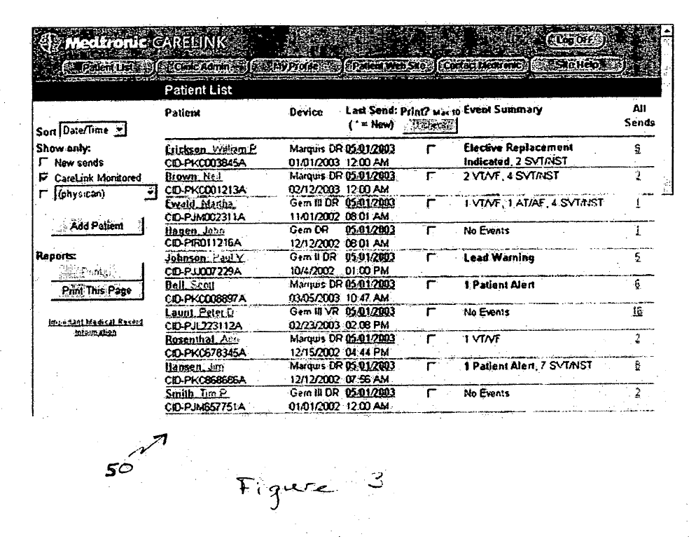

At a specified time, a medically trained caregiver logs onto the Medtronic CareLink® Network and accesses the device data. FIG. 3 shows representative graphical user interface (GUI) 50, which may be used to access the data. GUI 50 includes each patient's name and an identification number. It also provides the type of device that is collecting the data, the date and time of the last transmission of data, a summary of events or issues, and the number of times each patient has sent data. The data can be sorted to view only new transmissions, by caregiver, patient, etc. The caregiver simply selects patients in the group on GUI 50. GUI 50 highlights issues to increase efficiency of the initial review. Preferably, an indicator informs the caregiver whether a patient's data has been viewed. GUI 50, for instance, places an asterisk next to the date and time of transmission of non-reviewed data.

The caregiver identifies patients that have clinical or device issues. Such issues may include, for example, episodes that were treated by an IMD or where data from an IMD indicates low battery power. Full reports are created for these higher priority patients. The full reports include data that is relevant to an issue, such as a graphical representation of an episode treated by an IMD. The caregiver also prioritizes device reports for evaluation by identifying patients that have no issues. A brief report is printed for each of these lower priority patients. Typically, about 80% of patients have no issues that require additional review.

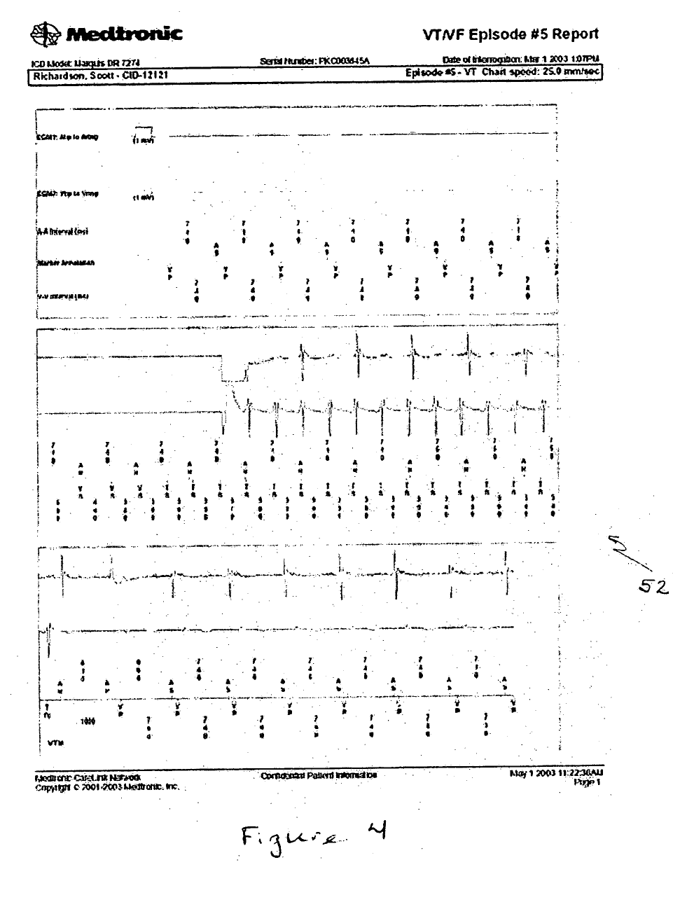

FIG. 4 shows graphical representation 52 that is based on data generated during a ventricular tachycardia/ventricular fibrillation (VT/VF) episode, which was indicated as an issue. Graphical representation 52 is printed as part of the report for a high priority patient.

The caregiver sorts the patient reports between two stacks. One stack contains the low priority reports, and the other stack contains the high priority reports. The sorted reports are then handed off to a second caregiver to evaluate the reports during a window of time that is scheduled for that purpose.

The second caregiver spends more time evaluating the full reports. The evaluating step includes evaluating the data and determining appropriate treatment and/or follow-up for the patient. Appropriate treatment may include, for example, being seen for an in-office visit, adjusting medication dosages, adjusting device parameters (in-office or remotely), or continuing with routine monitoring. The second caregiver also evaluates the brief reports knowing that these patients do not have any issues.

The results of the evaluation are entered into the patient records, and the results along with appropriate follow-up care are communicated to each patient of the group. Communication may be performed in any of a number of ways. For example, patients may be required to be available for contact from a caregiver during a window of time after evaluation. Another option is to contact patients having issues within a window of time occurring on the same day as the evaluation, while patients without issues are contacted within 24-48 hours. Alternatively, the results of the evaluations may be mailed to patients. Any combination of these examples or others may be used depending on the clinical situation and the workflow of the clinic.

The patient reports are then processed for billing for the services provided by the clinic. Again, the reports are processed as a batch.

Batch processing coupled with the high level of diagnostic information provided by medical devices allows for earlier detection of problems. It creates efficiencies that permit caregivers to follow problem patients more closely and be better able to optimally titrate therapy (device programming, drug initiation, drug titration, etc.).

Although the present invention has been described with reference to preferred embodiments, workers skilled in the art will recognize that changes may be made in form and detail without departing from the spirit and scope of the invention.

1. A method for managing data from remotely located patients, the method comprising:
receiving the data from a group of patients during a time period;
reviewing the data;
creating a batch of patient reports prioritized for amount of evaluation and response required based on the data received; and
evaluating the data based on the batch of patient reports.

2. The method of claim 1 and further comprising:
providing a prompt to the group of patients to transmit data within the specified time period.

3. The method of claim 2 wherein providing a prompt is performed prior to the time period.

4. The method of claim 2 and further comprising:
providing a further prompt of to patients of the group that have not transmitted data after the time period has ended.

5. The method of claim 1 and further comprising:
communicating with the patients of the group based on results of the evaluating.

6. The method of claim 5 wherein communicating further comprises:
reporting results of the evaluating; and
scheduling appropriate follow-up.

7. The method of claim 1 and further comprising:
processing the batch of patient reports for billing.

8. The method of claim 1 wherein a number of patients in the group is based on time allotted for review and evaluation.

9. The method of claim 1 wherein creating a batch of patient reports further comprises:
creating brief reports for patients that have no clinical or device issues based on the data received; and
creating full reports containing relevant information for patients that have clinical or device issues based on the data received.

10. The method of claim 1 and further comprising:
sorting patient reports based on the amount of evaluation and response required.

11. The method of claim 1 wherein reviewing, creating, and evaluating occurs within about a 24-hour period.

12. The method of claim 1 wherein the data is obtained from an implantable medical device.

13. A method of managing data from remotely located patients having implantable medical devices, the method comprising:
receiving, during a time period, implantable medical device data from a group of patients;
reviewing the data received as a batch;
creating patient reports that prioritize the patients for amount of evaluation and response required based on the data received; and
evaluating the data as a batch based on the patient reports.

14. The method of claim 13 wherein the data includes stored episodes.

15. The method of claim 13 wherein the data includes device issues.

16. The method of claim 13 wherein the implantable medical devices are interrogated by an external monitor.

17. The method of claim 13 wherein the data is received from an external monitor.

18. The method of claim 13 and further comprising:
providing a prompt to the patients of the group to transmit the data during the time period.

19. The method of claim 13 and further comprising:
communicating results of the evaluations and follow-up information with the patients.

20. The method of claim 13 wherein the group of patients is formed by randomly clustering patients.

21. The method of claim 13 and further comprising:
processing the patient reports for billing as a batch.

22. A method of managing medical data from remotely located patients, the method comprising:
selecting a group of patients for gathering and evaluation of device data from implantable medical devices;
receiving the device data transmitted by patients of the group;
storing the device data received from patients of the group in a network server;
creating a batch of reports for the patients of the group based on the device data stored in the network server; and
communicating with the patients of the group based upon the evaluating.

23. The method of claim 22 and further comprising:
scheduling a time period during which patients of the group transmit device data from their implantable medical devices.

24. The method of claim 22 wherein the patient reports are prioritized for amount of evaluation and response required.

25. The method of claim 22 wherein patients in the group are randomly selected.

26. The method of claim 23 wherein the time period scheduled for transmitting device data is between about 24 hours and about 48 hours prior to evaluation.

27. The method of claim 24 wherein the patient reports are sorted based on priority.

28. The method of claim 22 wherein communicating further comprises:
reporting results of the evaluating; and
scheduling appropriate follow-up.

29. The method of claim 22 and further comprising:
billing, as a batch, for services provided to the group of patients.

30. A method of managing medical data from remotely located patients having implantable medical devices, the method comprising:
scheduling a batch of patients for gathering and evaluation of device data from their implantable medical devices;
receiving a batch of the device data from the batch of patients;
storing the batch of device data in a network server;
accessing the batch of device data stored in the network server;
reviewing the batch of device data to prioritize patients based on amount of evaluating required;
evaluating the device data;
communicating results of evaluating to patients within the batch; and
billing, as a batch, for services provided to the batch of patients.

31. The method of claim 30 and further comprising:
generating a signal that is sensed by the implantable medical devices, the signal initiating transmission of the device data from the implantable medical devices.

32. The method of claim 30 wherein the patients within the batch initiate transmission of the device data from their implantable medical devices.

33. The method of claim 30 and further comprising:
creating patient reports based on reviewing the device data, the patient reports being utilized for evaluating the device data.

34. The method of claim 30 wherein communicating further comprises:
scheduling appropriate follow-up.

35. A method of interacting with patients having implantable medical devices, the method comprising:
scheduling a time period during which patients of a group are to transmit device data collected from their implantable medical devices;
receiving the device data transmitted by patients of the group;
storing the device data received from the patients of the group;
reviewing stored device data from the group as a batch;
creating patient reports containing device data based upon the reviewing;
reviewing the patient reports as a batch; and
communicating with the patients of the group based on reviewing the patient reports.

36. The method of claim 35 and further comprising:
transmitting a signal to the implantable medical device, which initiates transmission of device data from the implantable medical device.

37. The method of claim 35 wherein the patients of the group initiate transmission of the signal.

38. The method of claim 35 wherein an outside source initiates transmission of the signal.
